(19) United States
(12) Patent Application Publication
(10) Pub. No.: US 2013/0044769 A1
(43) Pub. Date: Feb. 21, 2013

(54) MEMS Q-Switched Monoblock Laser

(71) Applicants: John E. Nettleton, Fairfax Station, VA (US); Dallas N. Barr, Woodbridge, VA (US)

(72) Inventors: John E. Nettleton, Fairfax Station, VA (US); Dallas N. Barr, Woodbridge, VA (US)

(73) Assignee: United States of America, as represented by the Secretary of the Army, Fort Belvoir, VA (US)

(21) Appl. No.: 13/212,434

(22) Filed: Aug. 18, 2011

(51) Int. Cl. H01S 3/11

(52) U.S. Cl. 372/10

(57) ABSTRACT

A monoblock laser cavity incorporates optical components required for a short-pulse laser. These optical components are ‘locked’ into alignment forming an optical laser cavity for flash lamp or diode laser pumping. Optical alignment is not necessary after the optical laser cavity is fabricated. An exemplary Q-switched monoblock laser replaces the Cr:YAG Q-switch functionality with a MEMS scanner.

### GOVERNMENT INTEREST

The invention described herein may be manufactured, used, sold, imported, and/or licensed by or for the Government of the United States of America.

### FIELD OF THE INVENTION

This invention relates in general to laser cavities, and more particularly, to a monoblock laser cavity capable of producing short-pulse, eye safe laser.

### BACKGROUND OF THE INVENTION

Laser range finders are becoming an increasingly vital component in high precision targeting engagements. The precise and accurate range to target information is an essential variable to the fire control equation of all future soldier weapons. This information is easily, and timely, provided by laser range finders.

Unfortunately, current fielded laser range finders are bulky, heavy and expensive. These laser range finders were not developed with the individual soldier and his special needs in mind.

The Monoblock Laser makes the development/fabrication of a very low cost, compact laser range finder feasible. The Monoblock Laser is the cornerstone of the US Army's AN/PSQ-23 Small Tactical Optical Ranging Module (STORM) of which thousands have been fielded.

### SUMMARY OF THE INVENTION

A Q-switched monoblock laser can be based on a Micro-Electrical-Mechanical-System (MEMS) scanner. In one aspect, a lower cost MEMS Q-switch component is used to improve the optical-to-optical efficiency and to provide output emission control of the Monoblock Laser output pulse energy.

More generally, a monoblock laser cavity is disclosed. Such a monoblock laser cavity comprises a Q-switch; a laser gain medium has a medium portion joined at an angled partition with a cap, wherein the laser gain medium is based on a suitable laser material; and an optical parametric oscillator having an output coupler coating. At least said laser gain medium and said optical parametric oscillator are disposed as optical components in an arrangement along an optical axis of the laser cavity on a YAG pallet.

In another aspect, a monoblock laser cavity incorporates optical components required for a short-pulse laser. These optical components are ‘locked’ into alignment forming an optical laser cavity for flash lamp or diode laser pumping. The optical laser cavity does not need optical alignment after it is fabricated. An exemplary monoblock laser cavity is configured with a scanner to replace the Cr:YAG Q-switch component. Such a scanner can be either a Micro-Electrical-Mechanical-System (MEMS) scanner or a resonant optical scanner.

### BRIEF DESCRIPTION OF THE DRAWINGS

Additional advantages and features will become apparent as the subject. invention becomes better understood by reference to the following detailed description when considered in conjunction with the accompanying drawings wherein:

FIG. 1 shows a monoblock laser cavity based on a Cr:YAG Q-switch; and

FIG. 2 shows an exemplary embodiment of a monoblock laser cavity based on a MEMS Q-switch.

### DETAILED DESCRIPTION

A Q-switched monoblock laser is disclosed. An original monoblock laser cavity is based on a Cr:YAG Q-switch. However, exemplary embodiments based on a Micro-Electrical-Mechanical-System (MEMS) scanner or a resonant optical scanner are also disclosed. Such a scanner-based Q-switched monoblock laser can be used in lieu of a monoblock laser cavity based on a Cr:YAG passive Q-switch.

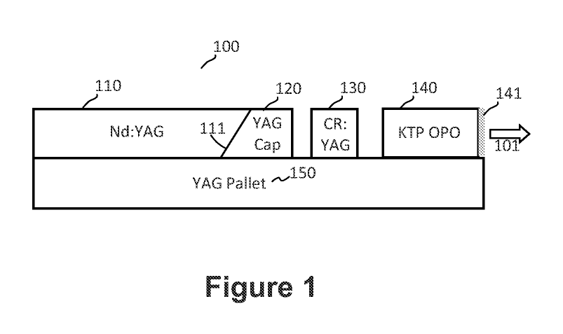

FIG. 1 depicts a monoblock laser cavity 100 based on a Cr:YAG Q-switch 130. As exemplified in FIG. 1, a laser gain medium has an Nd:YAG portion 110 partitioned by a Brewester's angle 111 from a YAG cap 120. Although the laser gain medium is disclosed as Nd:YAG, any of the numerous suitable laser materials can also be used. Said laser gain medium is followed by a CR:YAG passive Q-switch 130. The Q-switch 130 is then followed by a potassium titanyl phosphate (KTP) optical parametric oscillator (OPO) 140 having an output coupler coating 141. Said monoblock laser components rest on a YAG Pallet 150 as depicted in FIG. 1.

The Cr:YAG passive Q-switch (e.g., 130) works by holding off lasing in the Monoblock cavity until the proper laser threshold (think of it as a photonic pressure), as determined primarily by the optical density of the Cr:YAG Q-switch 130, is reached. Until the lasing threshold is reached, the Cr:YAG 130 is opaque at the lasing wavelength and prevents or holds off the lasing operation. But once this lasing threshold (pressure) is reached, the Cr:YAG rapidly (within nano-seconds) bleaches and becomes transparent to the laser wavelength. The laser is emitted 101 in a short pulse until the Cr:YAG 130 reverts back to its opaque state.

Unfortunately, the Cr:YAG passive Q-switch 130 does not become 100% transparent to the laser wavelength when it bleaches (it typically bleaches to about 50% transparency). The lack of total transparency means that the Cr:YAG passive Q-switch 130 is providing losses in the laser cavity 100 which leads to lower optical input to optical output efficiency.

The laser build up occurs in the laser gain medium which is Nd:YAG (e.g., 110) for the original Monoblock as seen in FIG. 1. The Nd:YAG material is pumped either by a flash lamp or by laser diodes. Much more control and greater electrical energy efficiency is achieved with laser diode pumping.

The fluorescence lifetime of Nd:YAG is about 230 micro-seconds. This is the average time the laser molecule stays in its excited state before emitting a photon which sets the time limits that the laser cavity can be pumped (efficiently or effectively). The pump time also determines the amount of energy that can be deposited into the laser cavity (pump power×time=energy into laser cavity) for future extraction.

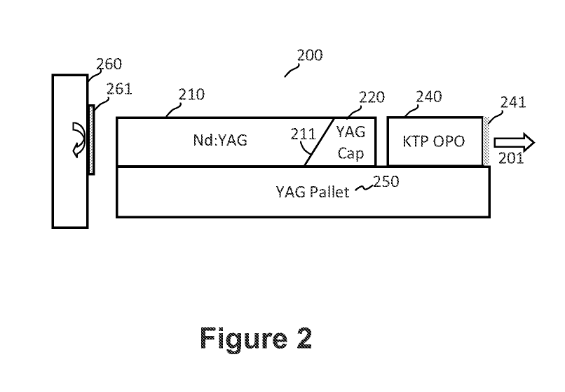

Another exemplary embodiment replaces the Cr:YAG Passive Q-Switch (e.g., 130) functionality with an active Q-Switch (e.g., 260) as shown in FIG. 2. FIG. 2 generically depicts an exemplary embodiment of a monoblock laser cavity 200 based on a scanner-based active Q-switch 260. Such a scanner Q-switch can be based on a Micro-Electrical-Mechanical-System (MEMS) scanner or a resonant optical scanner. As exemplified in FIG. 2, a laser gain medium has an Nd:YAG portion 210 partitioned by a Brewester's angle 211 from a YAG cap 220. Although the active laser medium can be Nd:YAG, any of the numerous suitable laser materials can also be used.

Said laser gain medium is followed by a potassium titanyl phosphate (KTP) optical parametric oscillator (OPO) 240 having an output coupler coating 241 at its emitting end 201. Said laser gain medium and said optical parametric oscillator are disposed as an arrangement on a YAG Pallet 250 as depicted in FIG. 2. The YAG 250 arrangement is preceded by a scanner Q-switch 260 based on either a MEMS scanner or a resonant optical scanner having a resonant mirror end 261 facing another end of said YAG pallet arrangement opposite to said emitting end 201 having said output coupler coating 241 such that the scanner resonant mirror 261 acts as a Q-switch.

The MEMS Scanner Active Q-Switch 260 is a resonant scanning device. Two commercially available scanners were tried with success. One scanner mirror is a single axis MEMS scanning based on a reflective mirror (OPUS Microsystems® BA0050). An alternative scanner mirror is an SC-5 resonant optical scanner available from Electro-Optical Products Corp. The disclosure encompasses those and any such commercially available scanning mirror suitable for use as a Q-switch when referring to a scanner-based Q-switch, a MEMS scanner or a MEMS mirror. The scanning mirror 261 is swept back and forth along the optical axis of the laser cavity 200. When the MEMS scanning mirror 261 is not aligned with the output coupler (e.g., 241) of the Monoblock Laser Cavity (e.g., outer face of the KTP OPO component 240) no lasing (hold off) can occur. But during a sweep, the MEMS mirror 261 will precisely align with the output coupler 241 and cause the built-up laser energy to emit 201 in a short pulse. There is no loss (blockage) of the laser during the Q-switching like there is in the Cr:YAG Passive Q-Switch case (e.g., FIG. 1) which leads to very efficient optical-to-optical output.

The resonant frequency of the MEMS scanner (260) is selected based on the allowable pump time (approximately the fluorescence lifetime of the gain media). The period of the resonant frequency should be longer than the pump time. For example, an exemplary monoblock laser cavity using Nd:YAG as the gain media has a fluorescence lifetime of about 230 micro-seconds which leads to a MEMS scanner 260 resonant frequency of about 4.3 KHz or less.

The Pump will be synchronized with the MEMS Scanner Active Q-Switch which provides an electronic signal, such as a sine wave, that is correlated to the minor position. The pump will begin at the precise time before the MEMS mirror 261 reaches the Q-Switch position (parallel with an axis of the output coupler 241).

A filtered photodetector tuned to the laser wavelength of the cavity (e.g. 1064 nm for the original Monoblock) which tracks the fluorescence building up inside the cavity can also be added. This will allow control of the final output laser emission over temperature extremes.

### ADVANTAGES

The variously described exemplary embodiment improves the optical efficiency of the monoblock laser and allows active control of the output laser emission (pulse energy). The MEMS Scanner Active Q-Switch also has the potential of being much less costly than the Cr:YAG Passive Q-switch. An electronic chip versus a semi-precious, grown laser crystal.

The Improved Monoblock Laser Cavity is still a simple module that requires none of the labor extensive alignment procedures as current laser range tinder solid state sources. No optical holders have to be fabricated, no complex engineering is required to design the optical cavity, and no precise laser cavity alignment(s) are required. Production labor and material costs are greatly reduced.

The Improved Monoblock Laser Cavity is a modular component. The modularity lends to ease of design for different pump sources. It can be incorporated in a flash lamp pumped or laser diode pumped system.

The active laser medium can be Nd:YAG or any of the numerous suitable laser materials.

### APPLICATIONS

The variously described embodiments may be used as the laser source in very compact laser range finders. The Monoblock generates eye safe laser output for eye safe laser range finding. These laser range finders have both military and commercial applications. The compact design of the Improved Monoblock Laser Cavity also lends itself to placement in other laser-based portable/hand-held devices. These may be medical devices, industrial tools or scientific equipment that would benefit from the size/weight reduction, dependable performance, and low cost.

It is obvious that many modifications and variations of the present invention are possible in light of the above teachings. It is therefore to be understood that within the scope of the appended claims, the invention may be practiced otherwise than as described.

1. A monoblock laser cavity, comprising:
a scanner Q-switch capable of a resonant frequency of about 4.3 KHz;
a laser gain medium having a medium portion joined at an angled partition with a cap, wherein the laser gain medium is based on a suitable laser material having a fluorescence lifetime of about 230 micro-seconds; and
an optical parametric oscillator having an output coupler coating, wherein at least said laser gain medium and said optical parametric oscillator are disposed as optical components in an arrangement along an optical axis of the laser cavity on a YAG pallet.

2. The monoblock laser cavity according to claim 1, wherein said laser gain medium has an Nd:YAG portion partitioned by a Brewester's angle from a YAG cap.

3. The monoblock laser cavity according to claim 1, wherein said optical parametric oscillator having an output coupler coating is a potassium titanyl phosphate optical parametric oscillator having an output coupler coating.

4. The monoblock laser cavity according to claim 1, wherein said optical components are disposed in an alignment to form an optical laser cavity for flash lamp or diode laser pumping, whereby said laser cavity does not need optical alignment upon fabrication.

5. (canceled)

6. The monoblock laser cavity according to claim 1, comprising a filtered photodetector tuned to a 1064 nm laser wavelength of the laser cavity for control of the output laser emission over a temperature range.

7. The monoblock laser cavity according to claim 1, wherein said scanner Q-switch is based on either a MEMS scanner or a resonant optical scanner having a resonant mirror end facing another end of said YAG pallet arrangement opposite to an emitting end having an output coupler coating such that a mirror of said scanner resonates to act as an active Q-switch.

8. The monoblock laser cavity according to claim 7, wherein said mirror resonates by sweeping back and forth along the optical axis of the laser cavity, wherein the mirror precisely aligning with the output coupler during a sweep causes a build-up of laser energy to emit in a short pulse without blockage.

9. The monoblock laser cavity according to claim 7, wherein the resonant frequency of the scanner is selected based on an allowable pump time.

10. The monoblock laser cavity according to claim 7, wherein said scanner active Q-switch provides an electronic signal, such as a sine wave, that is correlated to the mirror position such that a pump can begin at the precise time before the scanner mirror reaches a Q-switch position parallel with an axis of the output coupler coating.

11. The monoblock laser cavity according to claim 7, wherein said MEMS scanner is packaged as an electronic chip, and wherein a precise laser cavity alignment is not necessary.

12. The monoblock laser cavity according to claim 7, wherein said monoblock laser cavity is a modular component capable of interfacing with a pump source, incorporation in a flash lamp pumped system, or incorporation in a laser diode pumped system.

13. A compact laser range finder having the monoblock laser cavity according to claim 7 as its laser source.

14. A portable or hand-held laser device based on said monoblock laser cavity according to claim 7, wherein said laser device is for medical, industrial or scientific applications where size/weight reduction, dependable performance, and/or low cost are design considerations.

15. The monoblock laser cavity according to claim 7, wherein the resonant frequency of the scanner is about 4.3 KHz.

16. The monoblock laser cavity according to claim 15, wherein the fluorescence building up is detected to control the output laser emission over temperature extremes.
